(19) United States
(12) Patent Application Publication
(10) Pub. No.: US 2011/0248423 A1
(43) Pub. Date: Oct. 13, 2011

(54) Synthetic Mulch and Method of Making Same

(76) Inventors: Steven Proper, Adairsville, GA (US); Michael Proper, Resaca, GA (US)

(21) Appl. No.: 13/082,047

(22) Filed: Apr. 7, 2011

Related U.S. Application Data
(60) Provisional application No. 61/321,534, filed on Apr. 7, 2010.

(51) Int. Cl. C09K 17/52

(52) U.S. Cl. 264/140

(57) ABSTRACT

A synthetic mulch is disclosed formed of agglomerated plastic material that can be colored to have the look of a natural or organic mulch. The synthetic mulch can be formed from used plastic material, such as polyester, nylon, polypropylene and/or polyethylene, with polyester and/or nylon preferred.

A method of manufacturing the synthetic mulch is also disclosed that includes the steps of: a) obtaining plastic material; b) reducing the size of the plastic material, for example by cutting, chopping or grinding the used plastic material into pieces; c) agglomerating the plastic pieces; and d) solidifying the agglomerated pieces to form the synthetic mulch. In a further embodiment the pieces are agglomerated by introducing them into a densifier to form a particulate matter for use as the present synthetic mulch.

### FIELD OF THE PRESENT DISCLOSURE

The present disclosure relates generally to mulches for landscape use, for example for home gardens, flower beds and landscape plantings, and in particular to a synthetic mulch that can be used in place of conventional organic mulch. More specifically, the present synthetic mulch can be colored and textured to look like a natural or organic mulch.

### BACKGROUND

Mulches are used for landscaping, in particular for home gardens, flower beds and landscape plantings. Generally, any material that covers the soil surface around and under plants to protect and improve the area is considered a mulch. Mulches perform many functions. They help control weeds. They help regulate soil temperature. They help retain soil moisture and also reduce soil erosion. They also can improve the appearance of any planting site.

Mulches are generally divided into two groups—organic mulches and synthetic mulches. Organic mulches are typically made of plant material such as peat, wood shavings, bark (chips, shreds, chunks or nuggets), straw, hay, ground corn cobs, leaves, compost, saw dust, pine needles or boughs. Synthetic (or inorganic) mulches include clear or black plastic sheeting (typically polyethylene), heavy duty aluminum foil, tar paper, carpet pieces, and spun or woven polypropylenes.

Organic mulches have a number of drawbacks or disadvantages. For example, they often need replenishment or replacement due to degradation and/or washing away. Use of organic mulches, such as wood shavings, wood chips and bark, can use up natural resources. Increased slug problems can occur with organic mulches, especially in damp weather. Additionally, organic mulches have a tendency to wash away in heavy rain requiring replacement.

Synthetic mulches also have a number of drawbacks. Clear or black plastic sheeting is impermeable to rain water. Polypropylenes, available as a sheet or web in either a spun or woven form, allow some degree of permeability but are still laid out as a sheet and, thus, do not have the natural look of organic mulches such as wood shavings, bark or pine needles.

Concurrently, landfills are being filled up with plastic material, for example synthetic fibers, particularly non-recyclable fibers that are not biodegradable. Thus, there is also a need to find an alternative use for plastic material that is currently being dumped in landfills.

The present disclosure addresses the drawbacks of organic mulches and the desirability to find an alternative use for plastic material, in particular non-recyclable synthetic fibers, as well as a desire for a more aesthetically pleasing synthetic mulch.

### SUMMARY

Plastic materials, such as synthetic fibers and plastic packaging, are typically composed of either polyester, nylon, polypropylene, or polyethylene (either high or low density). To be recyclable these plastic materials must not include contaminants in the form, for example, of cotton, rayon or non-magnetic materials. These contaminants tend to block up the screens in an extruder when attempting to recycle the synthetic material and reform the recycled material by extrusion into a new product. Thus, at recycle plants, particularly when recycling synthetic fibers, if the material is not 100% pure the material is set aside and not used for recycle. The non-recyclable plastic material is ultimately sent to a landfill.

We have found, however, that contaminated used plastic materials can be formed into and recycled as a synthetic mulch product that can be used in place of organic mulch. Our synthetic mulch does not require replacement or replenishment like organic mulches. Our synthetic mulch can also be made to have a density such that it will not wash away in a heavy rain. Furthermore, it can be made to have a natural look and made to be more aesthetically pleasing than conventional synthetic mulches, such as polypropylene or polyester sheeting.

In one embodiment the synthetic mulch of the present disclosure is formed from agglomerated plastic material that can be colored to have the look of a natural or organic mulch. In another embodiment the synthetic mulch of the present disclosure can be made from used plastic material. In a further embodiment the used plastic material can be polyester, nylon, polypropylene and/or polyethylene, with polyester and/or nylon preferred. The used plastic material can include contaminants, such as cotton, rayon, paper, and non-magnetic materials.

In one embodiment, the method of manufacturing the synthetic mulch includes the steps of: a) obtaining used plastic material; b) reducing the size of the plastic material, for example by cutting, chopping or grinding the used plastic material into pieces; c) agglomerating the plastic pieces; and d) solidifying the agglomerated pieces to form the synthetic mulch. In a further embodiment the pieces are agglomerated by introducing them into a densifier to form a particulate matter for use as the present synthetic mulch. In a further embodiment a colorant can be introduced into the densifier to color the agglomerated plastic material and, if desired, to provide a final synthetic mulch material with a natural look.

Other forms of our present synthetic mulch and methods of making the mulch will be or will become apparent to one with skill in the art upon examination of the following and detailed description. All such additional mulches and methods of making them and their features and advantages are intended to be included within this description, are intended to be included within the scope of the present disclosure, and are intended to be protected by the accompanying claims.

### DETAILED DESCRIPTION

Disclosed herein are various embodiments of the present synthetic mulch and methods of making the mulch. Reference will now be made in detail to the description of the materials and various embodiments of our mulch. While several embodiments are described, there is no intent to limit the present disclosure to any one embodiment disclosed herein. On the contrary, the intent is to cover all alternatives, modifications and equivalents.

Our present synthetic mulch and methods of making the mulch overcome the above-described advantages of conventional organic and synthetic mulches. In one embodiment, a particulate synthetic mulch can be made of agglomerated plastic material, for example polyester, nylon, polypropylene and/or polyethylene. The plastic material can be used or recycled plastic material. In a further embodiment, polyester or nylon are preferred because they form a higher density particulate which does not tend to float away in rain or storm water. In a further embodiment, color can be added to make the agglomerated plastic material more natural looking and to address potential fading due to sun exposure.

In one embodiment our present synthetic mulch can be made by obtaining plastic material, for example any woven, non-woven plastic material or lint. In one embodiment the plastic material is composed of polyester, nylon, polypropylene or polyethylene, with polyester or nylon being preferred. The plastic material need not be pure. The plastic material can include one or more contaminants such as cotton, rayon, paper or non-magnetic metals. The polyethylene can be either high or low density polyethylene. Preferably the polyethylene is not pure and has contaminants. Pure polyethylene may have a tendency to float in water and float away in a rain storm. Depending upon the desired final color, the plastic material may, but need not be, separated by color prior to processing. The size of the plastic material is then reduced, for example by cutting, chopping or grinding the plastic material into pieces. In one embodiment the pieces may be about the size of a fist. The pieces are then agglomerated to form the plastic material into particles. The final size of the particles can vary depending upon processing time.

In one embodiment the plastic material is agglomerated in a densifier, also referred to as an agglomerator. The densifier builds friction causing the plastic material to agglomerate the plastic material into particles. The densifier can also further chop the plastic material into smaller pieces either prior to or while agglomerating the pieces. In one embodiment the particles may be about the size of marbles.

Agglomerators typically apply a two-phase process, both of which occur almost simultaneously to turn scrap plastic material into a form in which it can be used more easily in manufacturing. In a first phase, densifiers use the basic principle of heating and size-reducing plastic material, for example film, through a type of mechanical friction on the plastic material to bring the plastic material up to its gel point. This can be accomplished either through rotary chopping in a drum-type densifier or through high-pressure compression. High-pressure compression can be achieved with an extruder-type auger through rotating plates with a varied gap, or through other similar mechanisms. This first phase is desirable because it significantly reduces the bulk density of a plastic material, for example film, without resulting in thermal degradation.

In the second phase of agglomeration, the material is formed into a granular or irregular pellets or particles through one of several processes. For example, in one process the softened plastic material is quickly cooled, which, with the help of a rotating blade, causes the material to fracture into small pieces or granules. Other processes involve the use of pressure (or extrusion) to push the material through rotating plates, augers, or nested drums. Once the material leaves the extrusion pressure point, it solidifies and then may be cut or chopped into small granules or irregular pellets.

If desired, a colorant can be added to the plastic material while it is being processed in a densifier. In one embodiment the colorant may be the color of cement which results in a final product that has the color of rock or aggregate typically used for landscaping purposes. Suitable colorants include, but are not limited to, iron oxide pigments, carbon black, blue pigment powders, and any kind of water based colorant. Oil-based colorants can also be used. Textile dyes can be used, but they have a tendency to fade under UV rays of sunlight and, thus, may be improved with use of a UV protectant.

In an exemplary embodiment, the synthetic mulch of the present disclosure is produced by first obtaining used plastic material, for example any polyester or nylon material. In one embodiment the used plastic material is used polyester or nylon fiber, preferably not be pure. For example, contaminated polyester or nylon material is acceptable. Depending on the desired color, the plastic material may optionally be separated by color.

Next, the size of the plastic material is reduced. For example, the plastic material can be cut, chopped or ground into pieces until they are small enough, about the size of your fist, for a densifier to properly process. The pieces are then fed into a densifier and agglomerated.

In a conventional densifier, the plastic pieces are introduced and the densifier is operated in a manner such that the amperage of the densifier is maintained within a particular range. The operation of the densifier is further controlled by controlling the amount of water introduced into the densifier after the plastic pieces are fed into the densifier. Thus, in one embodiment, the plastic pieces are fed into the densifier and the operation of the densifier initiated. After initiation of the operation a batch of water is introduced into the densifier along with the plastic pieces. The densifier is allowed to continue to operate after the water is introduced until achieving the desired amount of agglomeration of the plastic material. If desired, an additional batch of water may be added and the agglomerator allowed to continue to operate after the second batch of water is introduced. This cycle of adding a batch of water and then allowing the densifier to continue to operate may be repeated several times depending on the final desired size of the agglomerated material. Typically the final size depends more on the amount of water added into the densifier and less with the amount of time the product is in the densifier. Typically introduction of less water results in larger final agglomerated pieces and vice versa.

In one embodiment a Cal-Sierra densifier can be used. The Cal-Sierra densifier is a batch densifier. In one embodiment between one hundred and two hundred pounds of loose plastic material are obtained and manually fed into the densifier's large, open-top, circular hopper. A rotary blade spins at the bottom of the hopper, shredding the plastic material and generating enough heat to form the plastic material into a soft, homogenous “doughnut” material. Cold water is then introduced into the densifier and onto the softened plastic material. The softened plastic material then solidifies into granules or small flakes.

Colored powder or a mixture of colored powder and water can be added into the densifier after the machine is holding all of the material for a particular product batch. This results in a more uniform coloration and look. The amount of color added may depend on the desired final product appearance.

When finished the door on the densifier is opened and the agglomerated plastic material is allowed to blow out of the densifier into a cooling mechanism. After the cooling the final synthetic mulch product is ready for packaging.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A method of manufacturing a synthetic mulch comprising the steps of:
a) obtaining a plastic material;
b) reducing the size of the plastic material;
c) agglomerating the pieces; and
d) solidifying the agglomerated pieces to form a synthetic mulch.

2. The method of claim 1, wherein the plastic material is a used or recycled plastic material.

3. The method of claim 2, wherein the plastic material is selected from a group of polyester, nylon, polypropylene or polyethylene material and combinations thereof.

4. The method of claim 1, wherein the plastic material is polyester or nylon material, or both.

5. The method of claim 1, wherein the step of reducing the size of the plastic material includes cutting, chopping, or grinding the plastic material into pieces.

6. The method of claim 1, wherein the step of agglomerating the pieces includes heating the pieces up to their gel point.

7. The method of claim 1, wherein a colorant is introduced to color the agglomerated plastic material.

8. The method of claim 7, wherein the colorant includes iron oxide, pigments, carbon black, blue pigment powders, a water based colorant, or an oil-based colorant.

9. The method of claim 1, wherein the pieces are agglomerated by introducing them into a densifier.

10. The method of claim 9, wherein the plastic pieces are introduced and the densifier is operated in a manner such that the amperage of the densifier is maintained within a particular range.

11. The method of claim 9, wherein the densifier is further operated by controlling an amount of water introduced into the densifier after the plastic pieces are fed into the densifier.

12. The method of claim 9, wherein after the initiation of operation of the densifier, a batch of water is introduced into the densifier along with the plastic pieces.

13. The method of claim 12, wherein the densifier is allowed to continue to operate after the water is introduced until achieving the desired amount of agglomeration of the plastic material.

14. The method of claim 12, wherein a second batch of water is added and the densifier allowed to continue to operate after the second batch of water is introduced.

15. The method of claim 9, wherein a colored powder or a mixture of colored powder and water is added into the densifier after the densifier is holding all of the plastic material for a particular product batch.

16. The method of claim 1, wherein the step of solidifying the agglomerated pieces includes cooling the agglomerated pieces.

17. The method of claim 16, wherein the cooling of the agglomerated pieces aids in fracturing the agglomerated pieces into pieces or granules to form the synthetic mulch.

18. The method of claim 16, wherein the solidifying of the agglomerated pieces includes introducing cold water onto the agglomerated pieces.

19. The method of claim 1, wherein the step of solidifying the agglomerated pieces further includes cutting or chopping the agglomerated pieces to form the synthetic mulch.

20. The method of claim 1, wherein after the synthetic mulch is formed it is cooled.
